(19) United States
(12) Patent Application Publication
(10) Pub. No.: US 2008/0209871 A1
(43) Pub. Date: Sep. 4, 2008

(54) Method of assembling an automotive air filter

(76) Inventor: Mark German, Mt. Braddock, PA (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/002,993

(22) Filed: Dec. 19, 2007

Related U.S. Application Data
(60) Provisional application No. 60/875,782, filed on Dec. 19, 2006.

(51) Int. Cl. B01D 50/00; B29C 65/54

(52) U.S. Cl. 55/385.3; 156/290

(57) ABSTRACT

A high performance automotive air filter is produced by injection molding a base piece and a cap piece, applying a layer of adhesive to the base and cap pieces, placing the base and cap pieces on the bottom and top edges of the air filter medium, and curing the adhesive layers to adhere the base and cap to the filter media.

### CROSS-REFERENCE TO RELATED APPLICATION

This application claims the benefit of U.S. Provisional Application No. 60/875,782 filed Dec. 19, 2006, which is incorporated herein by reference.

### FIELD OF THE INVENTION

The present invention relates to automotive air filters, and more particularly relates to a method of assembling such air filters.

### BACKGROUND INFORMATION

High performance automotive air filters comprise a filter media such as corrugated paper or cotton and a support structure typically made of thermoset plastic. Certain types of air filters are generally cylindrical or frustoconical with an open base and a closed top defining an internal volume of the filter. Such air filters have conventionally been assembled by pouring a two-part thermosetting urethane mixture into a mold shaped like the base of the air filter, placing the lower rim of the filter media against the uncured thermosetting urethane mixture in the mold, curing the thermoset base in the mold at a substantially constant elevated temperature, pouring a two-part thermosetting urethane mixture into a mold shaped like the cap of the air filter, placing the top rim of the filter media against the uncured thermosetting urethane in the mold, curing the thermoset cap in the mold at a substantially constant elevated temperature, and removing the assembled air filter from the molds.

This conventional assembly process has several drawbacks. The thick base and cap pieces take a relatively long time to cure, and the mold temperature must be kept at a substantially constant elevated temperature during the curing process. The conventional assembly procedure requires the use of many molds for the base and cap pieces in order to provide sufficient production volume. Furthermore, when removing the assembled air filters from the molds, the filter media can pull away from the base or cap if the base or cap stick in their molds.

The present invention has been developed in order to address these and other deficiencies of the prior art.

### SUMMARY OF THE INVENTION

An aspect of the present invention is to provide a method of making an automotive air filter comprising providing an injection molded base piece and an injection molded cap piece, applying a layer of adhesive to the base and cap pieces, placing the base and cap pieces on bottom and top edges of an air filter medium, and curing the adhesive layers to adhere the base and cap to the filter media.

Another aspect of the present invention is to provide a high performance air filter made by the above-noted method.

These and other aspects of the present invention will be more apparent from the following description.

### BRIEF DESCRIPTION OF THE DRAWINGS

FIG. 1 is a side view of a high performance air filter assembled in accordance with a method of the present invention.

FIG. 2 is a perspective view of an air filter cap piece made of injection molded thermoplastic urethane in accordance with an embodiment of the present invention.

FIG. 3 is a perspective view of an air filter base piece made of injection molded thermoplastic urethane which may be used in an air filter assembly method in accordance with an embodiment of the present invention.

FIG. 4 is a flow diagram illustrating a method of assembling an air filter in accordance with an embodiment of the present invention.

FIG. 5 is a photograph showing the bottom rim of a corrugated air filter media adhered to an injection molded thermoplastic urethane base in accordance with an embodiment of the present invention.

### DETAILED DESCRIPTION

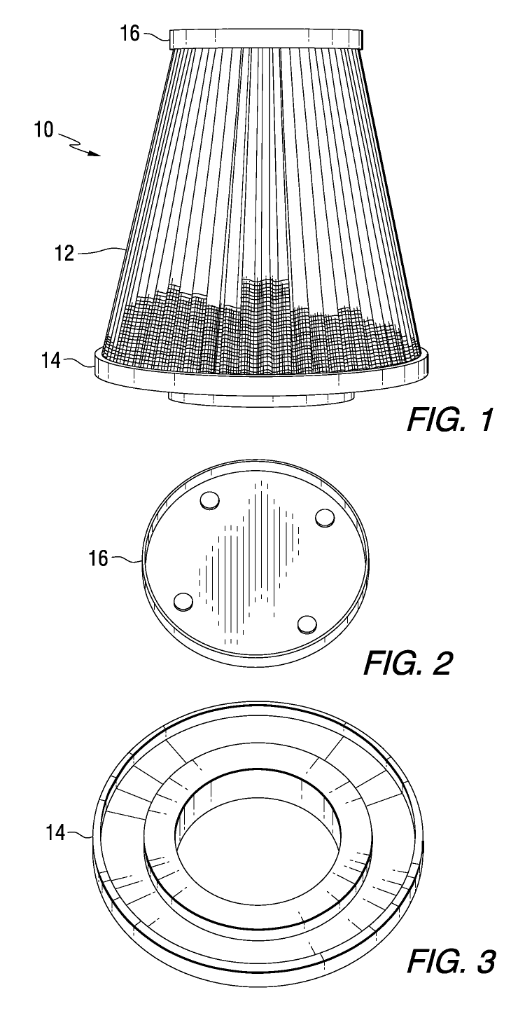

FIG. 1 illustrates a generally frustoconical air filter 10 assembled in accordance with an embodiment of the present invention comprising a high performance corrugated cotton filter material 12 adhered to thermoset urethane base 14 and cap 16 pieces. FIGS. 2 and 3 illustrate the cap 16 and base 14 of the filter 10, respectively, before the filter is assembled. Although a generally frustoconical air filter is shown in FIG. 1, other types of air filters may be assembled using the method of the present invention, such as cylindrical and rectangular designs. Some examples of high performance automotive air filters that may be produced in accordance with the method of the present invention are commercially available from Green High Performance Air Filter USA.

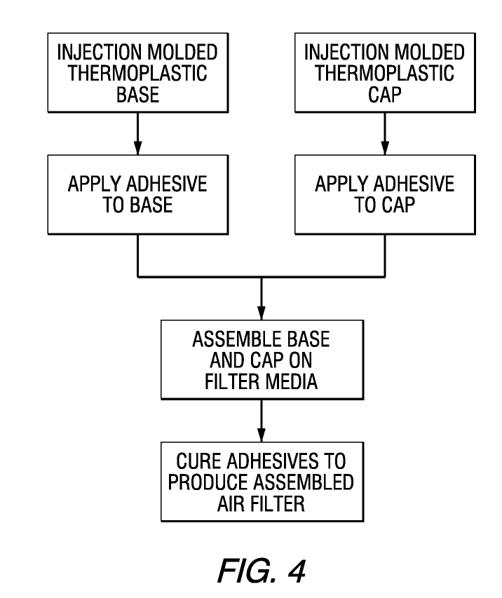

FIG. 4 is a flow diagram illustrating a method of making an automotive air filter in accordance with an embodiment of the present invention. A high performance automotive air filter is produced by injection molding a base piece and a cap piece, applying a layer of adhesive to the base and cap pieces, placing the base and cap pieces on the bottom and top edges of the air filter medium, and curing the adhesive layers to adhere the base and cap to the filter media. The injection molding step may be carried out with conventional injection molding equipment using commercially available thermoplastic urethane materials which are injected into a mold under pressure at elevated temperature. Upon cooling, the injection molded pieces are removed from the molds and the process is repeated such that many pieces may be made from a limited number of base and cap molds.

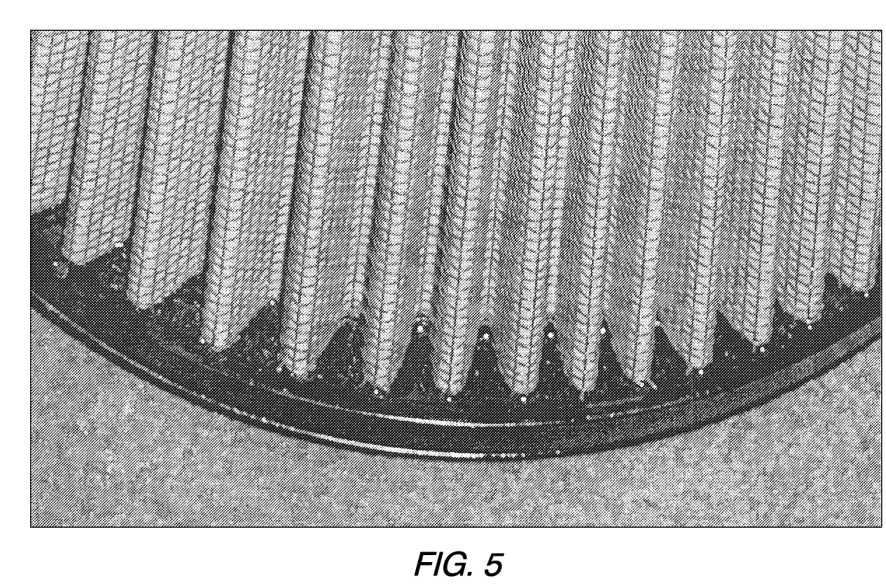

FIG. 5 is a photograph of the bottom rim of a corrugated air filter media adhered to an injection molded thermoplastic urethane base, illustrating the use of thermosetting urethane adhesive to securely attach the filter media to the base.

A suitable thermoplastic polyurethane material for injection molding to form the base and cap pieces is sold under the designation TEXIN 245 by Bayer Material Science Company. It is an aromatic polyester-based thermoplastic polyurethane with a shore hardness of about 45D.

In accordance with an embodiment of the present invention, the pre-formed base and cap pieces are adhered to the filter media through the use of any suitable type of adhesive. For example, a thin layer of a thermosetting two-part urethane mixture may be poured into the base and cap pieces, followed by placement on the filter media onto the base and cap pieces and curing of the adhesive. The use of a relative thin layer of thermosetting urethane adhesive securely fastens the base and cap to the filter media, while requiring a relatively short time for curing of the adhesive.

The present invention provides several advantages over conventional air filter assembly techniques. By using an injection moldable thermoplastic material, large numbers of base and cap pieces may be pre-formed relatively quickly using a relatively small number of molds. The use of adhesive to adhere the base and cap pieces to the filter media saves time because only thin layers of adhesive must cure during the process rather than the entire base and cap pieces. Furthermore, the present method avoids filter pull-away that can occur when conventional air filter assemblies are removed from their base and cap molds. The use of thermoplastic base and cap pieces in accordance with the present invention allows for recycling of the thermoplastic pieces in comparison with conventional thermoset pieces which are not recyclable.

Whereas particular embodiments of this invention have been described above for purposes of illustration, it will be evident to those skilled in the art that numerous variations of the details of the present invention may be made without departing from the invention as defined in the appended claims.

1. A method of making an automotive air filter comprising:
providing an injection molded base piece and an injection molded cap piece;
applying a layer of adhesive to the base and cap pieces;
placing the base and cap pieces on bottom and top edges of an air filter medium; and
curing the adhesive layers to adhere the base and cap to the filter media.

2. The method of claim 1, wherein the injection molded base and cap pieces comprise thermoplastic polyurethane.

3. The method of claim 1, wherein the adhesive comprises a two-part urethane mixture.

4. The method of claim 1, wherein the air filter medium is generally frustoconical.

5. The method of claim 1, wherein the air filter medium comprises corrugated cotton material.

6. An automotive air filter made by the method of claim 1.
